(19) United States
(12) Patent Application Publication
(10) Pub. No.: US 2008/0204744 A1
(43) Pub. Date: Aug. 28, 2008

(54) High Speed, Optically-Multiplexed, Hyperspectral Imagers and Methods Thereof

(76) Inventors: Jose Mir, Rochester, NY (US); R. Mark Boysel, Honeoye Falls, NY (US)

Correspondence Address: JAECKLE FLEISCHMANN & MUGEL, LLP, 190 Linden Oaks, ROCHESTER, NY, 14625-2812, US

(21) Appl. No.: 11/995,362

(22) PCT Filed: Jul. 11, 2006
(86) PCT No.: PCT/US2006/026776

§ 371 Date: Jan. 11, 2008

Related U.S. Application Data
(60) Provisional application No. 60/698,200, filed on Jul. 11, 2005.

(51) Int. Cl. G01J 3/40

(52) U.S. Cl. 356/303

(57) ABSTRACT

High speed, optically-multiplexed, hyperspectral imagers and methods for producing multiple, spectrally-filtered image information of a scene. In a preferred embodiment, an array of imaging lenslets project multiple images of a scene along parallel optical paths which are then collimated, filtered into distinct wavelengths, and focused onto an array of image sensors. A digital image formatter converts output data from the image sensors into hyperspectral image information of the scene.

### FIELD OF THE INVENTION

The present invention generally relates to imaging systems and methods and, more particularly, to high speed, optically-multiplexed, hyperspectral imagers and methods thereof.

### BACKGROUND

Hyperspectral imaging is increasing its use in a number of applications, such as remote sensing, agriculture, homeland security, and medicine. Typically, hyperspectral imaging involves the use of moving dispersive optical elements, such as prisms or gratings, lenses or mirrors, spatial filters, such as slits, and image sensors that are able to capture image content at multiple wavelengths.

The resulting data is often formatted electronically as a “data cube” comprising stacked 2D layers corresponding to the imaged surface, each stack layer corresponding to wavelength. Due to the mechanical motion required, needed electronic integration times, and other limiting factors, data cube capture can be a slow process, especially for a large number of wavelengths. Even devices using high speed actuators or microactuators require on the order of one second to capture a full data cube comprising 25-50 spectral bands.

### SUMMARY

A compact high speed hyperspectral imager in accordance with embodiments of the present invention includes: a linear or an area array of imaging lenslets that project multiple images of a scene along parallel optical paths; an array of collimating lenslets aligned in the parallel optical paths with the array of imaging lenslets; an array of narrow band-pass filters associated with the array of collimating lenslets designed to transmit a number of distinct wavelengths; a final imaging stage where multiple spectrally-filtered images of the scene are focused onto an array of image sensors; and a digital image formatter that converts output data from the image sensors into hyperspectral image information of the scene.

The preset invention provides a system and method to capture hyperspectral data cubes in parallel at very high rates. With the present invention, there are no moving parts required for operation and the present invention is quite robust to vibration and other harsh environments. Due to its optical and electronic simplicity, the present invention lends itself to modularity, i.e. an imaging module may be replicated to achieve gains in either spatial or spectral resolution at a given image capture rate. The present invention may also be broadly applicable to many regions of the spectrum depending on the choice of imaging components and sensor.

### BRIEF DESCRIPTION OF THE DRAWINGS

FIG. 1 is a block diagram of a high speed, optically-multiplexed, hyperspectral imager in accordance with embodiments of the present invention;

FIG. 2 is a diagram of a high speed, optically-multiplexed, hyperspectral imager in accordance with other embodiments of the present invention; and

FIGS. 3A-3E illustrate steps of a method of making an array of narrow band-pass filters.

### DETAILED DESCRIPTION

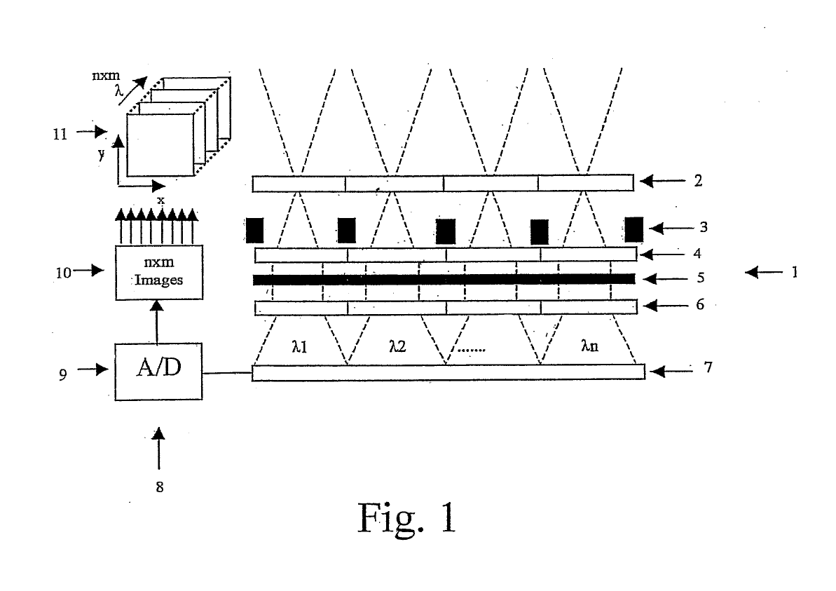

A high speed, optically-multiplexed, hyperspectral imager 1 in accordance with embodiments of the present invention is illustrated in FIG. 1. The high speed, optically-multiplexed, hyperspectral imager 1 includes a linear or an area array 2 of imaging lenslets, an array 4 of collimating lenslets, an array 5 of narrow band-pass filters, an array 6 of imaging lenslets, an array 7 of image sensors, and an image processing system 8, although the hyperspectral imager can comprise other numbers and types of components in other configurations. The present invention provides a number of advantages including providing a system and method to capture hyperspectral data cubes in parallel at very high rates.

Referring to FIG. 1, the multiplexed hyperspectral imaging module or imager 1 includes a one or two dimensional array 2 of lenslets having dimensionality n or n×m, respectively. Each of the lenslets in the array 2 images a scene in parallel onto an array 4 of collimating lenslets.

A set of light baffles or stops 3 are located between the array 2 of lenslets and the array 4 of collimating lenslets and is used along the optical path to keep light from entering adjacent collimating lenslets in array 4, although other numbers of light baffles can be used, such as just one light baffle. The array 4 of collimating lenslets approximately collimate light incident on them and transmit this collimated light to an array 5 of narrow band-pass filters.

The filters in the array 5 may be interference type filters achieved by multiple deposition of thin film layers, although other approaches for making filters that provide the required spectral properties can be used. Each filter in the array 5 transmits a specific spectral band of light λ₁ to λₙ to a final array 6 of imaging lenslets which image the multiple filtered images of the scene onto an array 7 of image sensors.

As a result of the array 5 of filters, multiple images of the scene that each carry spectral information corresponding to the respective transmitted wavelength λ₁ to λₙ are imaged on the array 7 of image sensors. For an array of n×m narrow band-pass filters 5, a total of n×m images can be captured by the array 7 of image sensors simultaneously, each at a unique spectral band λ₁ to λₙ. The array 7 of image sensors must be chosen to have sensitivity at all spectral bands transmitted by the array 5 of filters.

After capturing the images, the array 7 of image sensors outputs the image data to an image processing system 8 which includes a digital-to-analog converter 9 and an image formatter 10, although the image processing system 8 could comprise other types and numbers of components in other configurations. The digital-to-analog-converter 9 converts the captured images to digital data which is supplied to the image formatter 10, where the n×m images are reconstructed corresponding to the number of lenslets and bandpass filters in the arrays 2 and 5, respectively. The result output by the image formatter 10 is a set of stacked images known as a “data cube” 11 which is a representation of x-y image data sets stacked as wavelength layers. The image formatter 10 can be used to analyze data cube information, selecting and enhancing specific wavelength image layers for analysis and display, although other hyperspectral image processing systems could be used. It should be noted that larger dimensionality data cubes or higher capture frame rates may be achieved by using multiple hyperspectral imagers 1 in parallel (each with their associated image processing systems), such that they either cover a greater wavelength range and/or a greater number of imaging pixels.

The image formatter 10 comprises a central processing unit (CPU) or processor and a memory which are coupled together by a bus or other link, although other numbers and types of components in other configurations and other types of systems, such as an ASIC could be used. The processor executes a program of stored instructions for one or more aspects of the present invention including the method for image formatting and hyperspectral image processing and analysis as described and illustrated herein. The memory stores these programmed instructions for execution by the processor. A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to the processor, can be used for the memory to store these programmed instructions.

The selection and processing of the wavelengths chosen by hyperspectral imager 1 for use in a data cube 11 depends on the particular application. For example, the hyperspectral imager 1 may select infrared wavelength layers to reveal internal features of objects since the depth of penetration is greater in the infrared than in the visible. Wavelengths that correspond to the absorption of specific chemical species, biological diseased states, bacteria, infection, soil quality, fruit ripeness, or hazardous chemicals may be chosen and accentuated for analysis and display by hyperspectral imager 1. In military applications, camouflaged snipers or moving vehicles may need to be detected hyperspectrally to rapidly ascertain their presence and avoid potential danger. For these reasons, there is a need for hyperspectral imager 1 which can capture, process, and view data cubes dynamically. High speed optically-multiplexed hyperspectral imagers, such as hyperspectral imager 1, due to their rapid capture rate are highly useful for applications where video rates and real time hyperspectral analysis must be made.

An example illustrating the timing and performance of a high speed optically-multiplexed hyperspectral imager in accordance with embodiments of the present invention will now be described. If, for example, the total linear resolution of the array 7 of image sensors is N and the number of lenslets in array 2 along that direction is n, the maximum resolution per imaged scene will be N/n. Similarly, if the total linear resolution of the array 7 of image sensors is M along the perpendicular direction and the number of lenslets in array 2 along that direction is m, the maximum resolution per imaged scene will be M/m. The number of spectral bands captured per sensor frame in this case will be n×m, whereas the total number of cubes/second captured equals the sensor capture frame rate. More specifically, a 3K×2K sensor array outputting frames at 30 fps when used with a 6×6 array 2 of lenslet and array 5 of bandpass filters would be able to capture hyperspectral data cubes at 30 fps, containing 36 spectral bands, each at an image resolution of approximately 512×340 pixels.

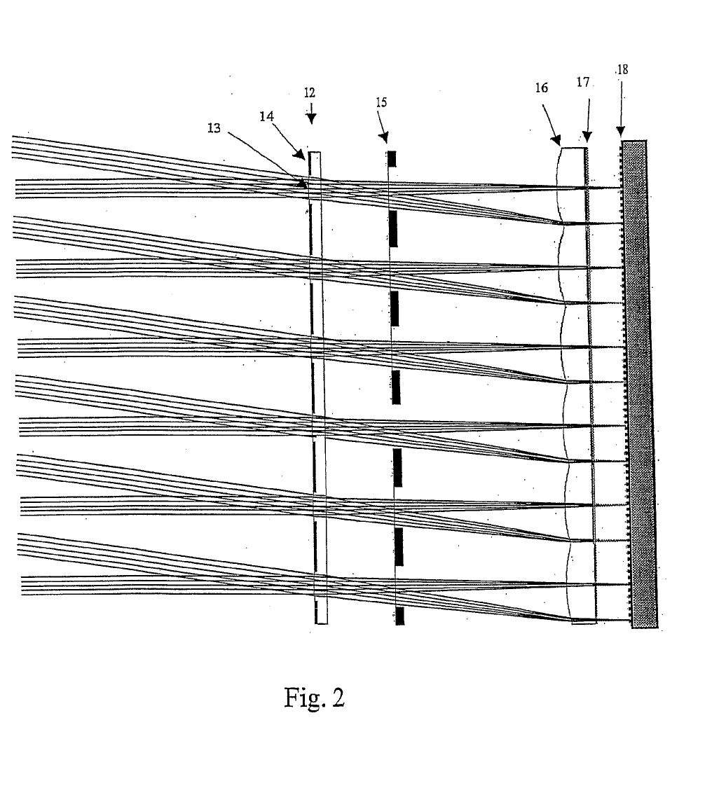

Referring to FIG. 2, another multiplexed hyperspectral imaging imager in accordance with other embodiments of the present invention is illustrated. The imager includes an array 12 of lenslets comprising several small lenslets in array 13 arranged periodically either in a one or two-dimensions. An opaque optical mask 14 surrounds each lenslet in array 13 to allow only light imaged through the lenslets 13 to be transmitted through the lenslet array 12. Sets of light baffles or stops 15 are placed along the optical path to keep light from entering adjacent optical systems, although other numbers of sets of baffles can be used.

An array 16 of plano-convex field lenslets (other types of positive lenses will also work, as well as multi-element positive lenses) with a focal length approximately equal to the distance to the array 13 of lenslets, approximately collimate light emanating from their corresponding lenslets in array 13. On the flat side of the plano-convex lenslet, an array 17 of narrow band-pass filters, each having a different peak transmission wavelength transmits light having different peak transmission wavelengths to the array 18 of image sensors. The array 18 of image sensors is chosen to have sensitivity at all wavelengths transmitted by the array 17 of narrow band-pass filters. The resulting image data is handled by an image processing system 8 as described above with reference to FIG. 1.

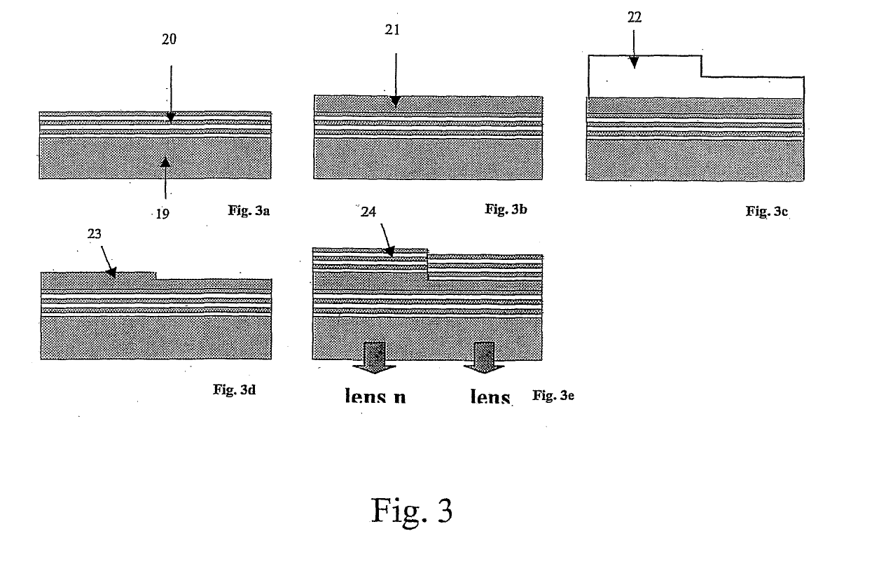

The fabrication and performance of the narrow band-pass filters in the array 17 is important. Referring to FIGS. 3A-3E, a method to fabricate the filters in array 17 based on grayscale lithography is illustrated, although other methods for making the filter in array 17 can be used. A transparent substrate 19 is coated with multilayer dielectric mirrors 20 or another reflecting surface as shown in FIG. 3A. Next, a transparent thin film layer 21 is coated over multilayer dielectric mirrors 20 to provide the conditions for optical constructive interference as in a Fabry-Perot interferometer as shown in FIG. 3B. A grayscale photoresist 22 is coated, exposed and patterned such that a number of thickness steps are achieved over the useful area of the wafer as shown in FIG 3C. The wafer is then milled or etched using well known techniques in the art of microfabrication to result in a corresponding graded step pattern on transparent thin film layer 21 as shown in FIG. 3D. Finally, another set of dielectric or other reflecting surface is deposited over the graded layer 21 as shown in FIG. 3E. The number of layers used in multilayer dielectric mirrors 20, their refractive index, the thickness and index of transparent thin film layer 21 will determine the peak wavelength transmitted, “finesse”, and transmissivity of the narrow band-pass filters in array 17 as is well-known to those of ordinary skill in the art. It should be noted that other fabrication processes may be used to achieve variable thicknesses for 23 such as controlled evaporation of 21 through a shadow mask while varying deposition rates.

In some cases it may be advantageous to fabricate the array 17 of narrow band-pass filters directly on the plano-convex field lenslets 16. Still another approach is to use grayscale lithography to produce the convex portion of plano-convex field lenslets 16. Since each filter in the array 17 is specifically designated to a plano-convex field lenslet 16, chromatic aberrations and other wavelength effects may be corrected for by designing each plano-convex field lenslets 16 or associated lenslet in array 13 to have the desired optical properties, e.g. different lens curvatures needed to compensate for refractive index dispersion at the various wavelengths.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. An imaging system comprising:
an array of imaging lenslets that project multiple images of a scene along parallel optical paths;
an array of collimating lenslets aligned in the parallel optical paths with the array of imaging lenslets;
an array of filters aligned in the parallel optical paths with the array of collimating lenslets, wherein each of the filters transmits a different wavelength;
an image sensor array;
an array of imaging lenslets which focuses images at different wavelengths on to the array of image sensors; and
an image processing system that converts output data from the array of image sensors into hyperspectral image information of the scene.

2. The system as set forth in claim 1 wherein the array of imaging lenslets is a linear array of imaging lenslets.

3. The system as set forth in claim 1 wherein the array of imaging lenslets is an area array of imaging lenslets.

4. The system as set forth in any one of claims 1 to 3 wherein each of the filters in the array is a narrow band pass filter.

5. The system as set forth in any one of claims 1 to 4, and further comprising at least one baffle between the array of lenslets and the array of collimating lenslets.

6. The system as set forth in any one of claims 1 to 5 wherein the array of imaging lenslets further comprises an opaque optical mask with openings for each lenslet in the array of lenslets.

7. The system as set forth in any one of claims 1 to 6 wherein the array of imaging lenslets further comprises an array of plano-convex field lenslets.

8. The system as set forth in any of claims 1 to 6 wherein the array of imaging lenslets comprises an array of positive field lenslets.

9. The system as set forth in claim 7 wherein the array of filters is on a flat surface of the array of plano-convex lenslets.

10. The system as set forth in claim 7 wherein the array of filters is on a flat surface of multi-element positive field lenslets.

11. A method for making an imaging system, the method comprising:
providing an array of imaging lenslets that project multiple images of a scene along parallel optical paths;
aligning an array of collimating lenslets to be in the parallel optical paths with the array of imaging lenslets;
aligning an array of filters to be in the parallel optical paths with the array of collimating lenslets, wherein each of the filters transmits a different wavelength;
providing an image sensor array;
arranging an array of imaging lenslets to focus the different wavelengths on to the image sensor array; and
converting output data from the one or more array of image sensors into hyperspectral image information of the scene.

12. The method as set forth in claim 11 wherein the array of imaging lenslets is a linear array of imaging lenslets.

13. The method as set forth in claim 11 wherein the array of imaging lenslets is an area array of imaging lenslets.

14. The method as set forth in any one of claims 11 to 13 wherein each of the filters in the array is a narrow band pass filter.

15. The method as set forth in any one of claims 11 to 14, and further comprising at least one battle between the array of lenslets and the array of collimating lenslets.

16. The method as set forth in any one of claims 11 to 15 wherein the array of imaging lenslets further comprises an opaque optical mask with openings for each lenslet in the array of lenslets.

17. The method as set forth in any one of claims 11 to 16 wherein the array of imaging lenslets further comprises an array of plano-convex field lenslets.

18. The method as set forth in any one of claims 11 to 16 wherein the array of imaging lenslets further comprises an array of positive field lenslets.

19. The method as set forth in claim 18 wherein the array of filters is on a flat surface of the array of plano-convex lenslets.

20. The method as set forth in claim 18 wherein the array of filters is on a flat surface of the array of multi-element positive field lenslets.
